(19) United States
(12) Patent Application Publication
(10) Pub. No.: US 2026/0300712 A1
(43) Pub. Date: Oct. 1, 2026

(54) SCALING ELEMENT-WISE OPERATIONS OF A NEURAL NETWORK

(71) Applicant: NVIDIA Corporation, Santa Clara, CA (US)

(72) Inventors: Steve Dai, Union City, CA (US); Muya Chang, Bellevue, WA (US); Rangharajan Venkatesan, Santa Clara, CA (US)

(21) Appl. No.: 19/091,697

(22) Filed: Mar. 26, 2025

(51) Int. Cl. G06N 3/08; G06N 5/04

(52) U.S. Cl. CPC G06N 3/08; G06N 5/04

(57) ABSTRACT

Neural networks, and in particular deep neural networks, are traditionally resource intensive as they require execution of a significant number of computations in order to generate an output. In an effort to accelerate neural networks, quantization has been employed in which the input/output of certain operations are scaled. However, the degree to which a neural network can be quantized is limited because current scaling methods, which do not ensure consistent scaling for operands, cannot be applied to the commonly used element-wise operations (e.g. addition and subtraction). The present disclosure provides scaling of element-wise operations in a neural network by using scale factors that are shared between operands, thus allowing for greater quantization of neural networks.

### TECHNICAL FIELD

The present disclosure relates to neural network operations.

### BACKGROUND

Neural networks, and in particular deep neural networks, are traditionally resource intensive as they require execution of a significant number of computations in order to generate an output. As a result, resource intensive neural networks generally cannot be deployed to resource constrained devices. This has led to efforts to find solutions to accelerate neural networks.

One common solution has been to reduce the precision of the neural network by scaled quantization. Current scaling methods used in scaled quantization involve independently computing the scale factor for each operand to an operation and as a result the scales factors may differ among the operands to an operation. While this method of scaling can be used for some operations in which the operands can be scaled differently (e.g. multiplication), this is not the case for element-wise operations such as addition and subtraction which require a same scale factor for all operands to a single operation.

The inability to employ current scaling methods with element-wise operations is a significant limiting factor for neural network acceleration. In particular, element-wise operations are commonly found in deep neural networks including transformers, and furthermore these operations are not only memory intensive as they have no data reuse across computations but since they are typically performed in certain floating-point formats, such as FP32 or BF16, they place high demands on memory bandwidth.

There is a need for addressing these issues and/or other issues associated with the prior art. For example, there is a need to provide scaling of element-wise operations in a neural network.

### SUMMARY

A method, computer readable medium, and system are disclosed for scaling an element-wise operation in a neural network. One or more scale factors to be used for an element-wise operation of a neural network are determined. Operands to the element-wise operation are scaled by the one or more scale factors to form scaled operands. The element-wise operation is performed on the scaled operands to generate a scaled output.

### BRIEF DESCRIPTION OF THE DRAWINGS

FIG. 1 illustrates a flowchart of a method for scaling an element-wise operation in a neural network, in accordance with an embodiment.

FIG. 2 illustrates a block diagram of the inputs and outputs to a scaled element-wise operation of a neural network, in accordance with an embodiment.

FIG. 3 illustrates a flowchart of a method for using statistics computed on the operands of an element-wise operation in a neural network to define one or more scale factors for the operands of the element-wise operation, in accordance with an embodiment.

FIG. 4 illustrates a flowchart of a method for using statistics computed on an output of an element-wise operation in a neural network to define one or more scale factors for operands of the element-wise operation, in accordance with an embodiment.

FIG. 5A illustrates inference and/or training logic, according to at least one embodiment.

FIG. 5B illustrates inference and/or training logic, according to at least one embodiment.

FIG. 6 illustrates training and deployment of a neural network, according to at least one embodiment.

FIG. 7 illustrates an example data center system, according to at least one embodiment.

### DETAILED DESCRIPTION

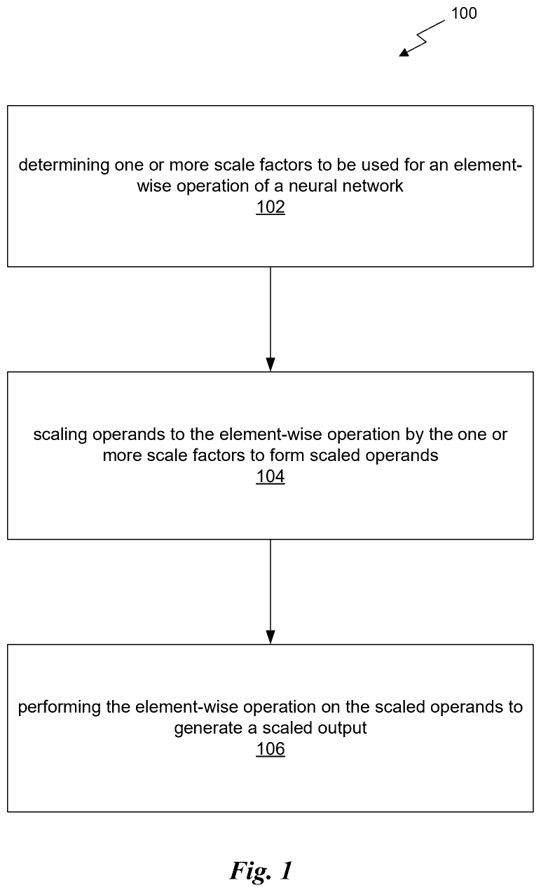

FIG. 1 illustrates a flowchart of a method 100 for scaling an element-wise operation in a neural network, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present description, the neural network refers to any type of neural network that includes an element-wise operation. In an embodiment, the neural network may be a deep neural network. In an embodiment, the neural network may be a transformer. In an embodiment, the neural network may have multiple layers each configured with a same element-wise operation. In an embodiment, the element-wise operation may be included in a processing node of the neural network. In an embodiment, the neural network may include a plurality of element-wise operations, in which case the method 100 may be performed to scale each element-wise operation of the plurality of element-wise operations.

The element-wise operation refers to a mathematical operation that is performed on two or more operands input to the element-wise operation. As described herein, these operands are scaled in accordance with the method 100 such that the element-wise operation operates on the scaled operands to generate a scaled output. In embodiments, the element-wise operation may be an element-wise addition operation or an element-wise subtraction operation.

The operands refer to data elements. In an embodiment, the operands may be tensors. In an embodiment, the operands may each include at least a portion of a tensor.

Returning to the method 100, in operation 102, one or more scale factors to be used for an element-wise operation of a neural network are determined. The scale factor refers to a factor (i.e. value) by which operands to the element-wise operation are scaled. In an embodiment, a single scale factor may be determined to be used for the element-wise operation.

In another embodiment, a set of scale factors comprised of a plurality of scale factors may be determined to be used for the element-wise operation. Further to this embodiment, each scale factor in the set of scale factors may be determined for a same respective portion of each of the operands. Just by way of example, a shared (e.g. common, same, etc.) scale factor may be determined for both a first row of a first operand to the element-wise operation and a first row of a second operand to the element-wise operation. Of course, in other examples the shared scale factor may be determined per operand row sub-part, operand column, operand column sub-part, or operand n-dimensional block. In an embodiment, two or more scale factors in the set of scale factors may be different.

In an embodiment, the at least one scale factor (i.e. the single scale factor or the set of scale factors) may be statically defined for the element-wise operation. Further to this embodiment, the at least one scale factor may be statically defined based on a performance of the element-wise operation on different operands comprised of representative input data. In an embodiment, the at least one scale factor may be statically defined based on statistics computed on a union of the different operands. As another option that is further to the aforementioned embodiment, the at least one scale factor may be statically defined based on statistics computed on an output of the performance of the element-wise operation on the different operands.

As yet another option that is further to the aforementioned embodiment, the at least one scale factor may be statically defined by (1) obtaining a first scale factor statically defined based on statistics computed on a union of the different operands, (2) obtaining a second scale factor statically defined based on statistics computed on an output of the performance of the element-wise operation on the different operands, (3) computing a first mean square error between a first output of the element-wise operation when performed on the different operands and a second output of the element-wise operation when performed on the different operands when scaled with the first scale factor, (4), computing a second mean square error between a third output of the element-wise operation when performed on the different operands and a fourth output of the element-wise operation when performed on the different operands when scaled with the second scale factor, (5) selecting, as the at least one scale factor, the first scale factor when the first mean square error is lower than the second mean square error, and (6) selecting, as the at least one scale factor, the second scale factor when the second mean square error is lower than the first mean square error.

In any embodiment where the at least one scale factor is statically defined, such static definition may be made for the element-wise operation during training of the neural network, where the representative input data used as operands to the element-wise operation may be training data.

In an embodiment, the at least one scale factor may be dynamically defined as a function of data included in the operands. In an embodiment, the at least one scale factor may be dynamically defined based on statistics computed on a union of the operands. In an embodiment, the at least one scale factor may be dynamically defined for the element-wise operation during inferencing by the neural network, namely on the operands that comprise real-time input data.

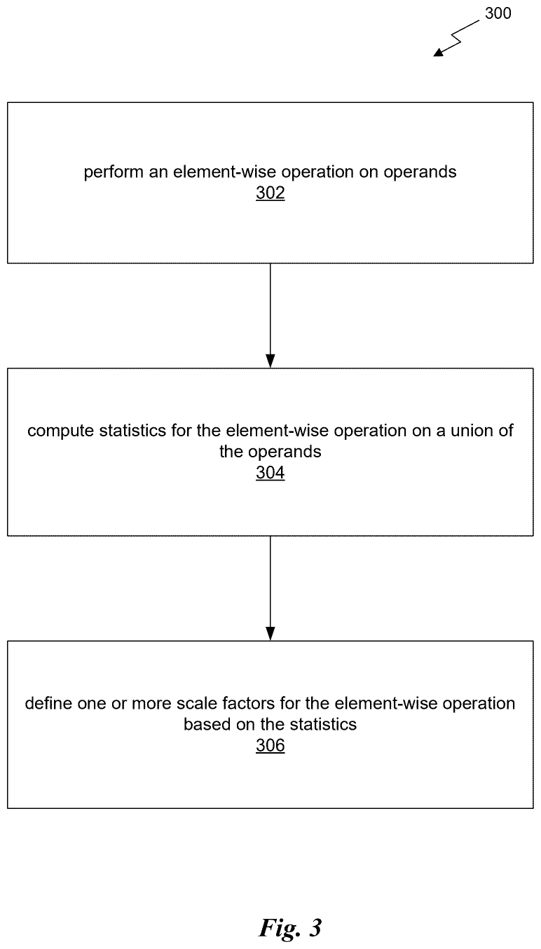

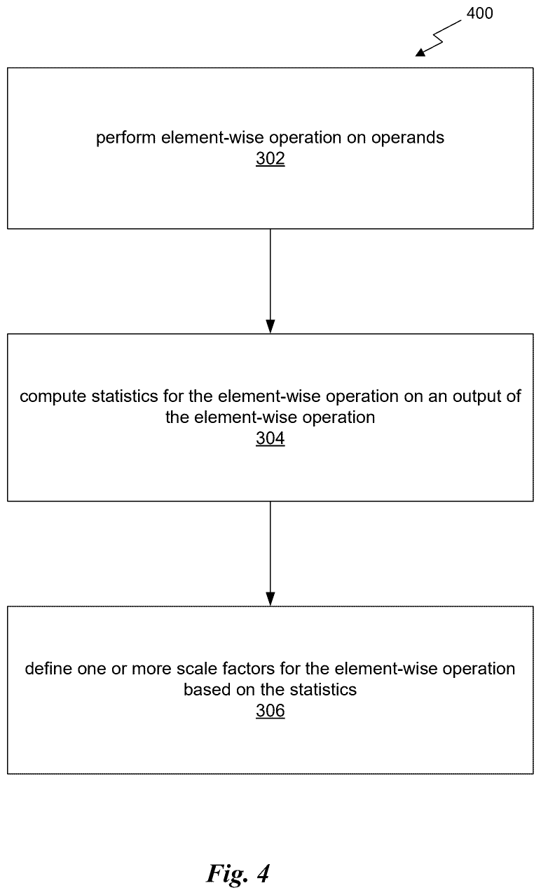

In yet another embodiment where a set of scale factors is determined to be used for the element-wise operation, the plurality of scale factors included in the set may include at least one statically defined scale factor and at least one dynamically defined scale factor. One or more of the scale factor(s) may be statically defined as described above, while one or more other scale factor(s) may be dynamically defined as described above. Additional embodiments for defining the single scale factor or set of scales factors for the element-wise operation will be described below with reference to FIGS. 3 and 4.

In operation 104, operands to the element-wise operation are scaled by the one or more scale factors to form scaled operands. In other words, the one or more scale factors are shared with respect to the operands. As a result, likewise scaling of the operands is performed.

In an embodiment where a single scale factor is determined for the element-wise operation, then all operands to the element-wise operation may be scaled by the single scale factor. In another embodiment where a set of scale factors comprised of a plurality of scale factors is determined for the element-wise operation, then all operands to the element-wise operation may be scaled by the set of scale factors with each scale factor applied to a same portion (e.g. row) of all of the operands for which the scale factor was determined.

In an embodiment, a preconfigured mathematical operation may be performed on the operands using the at least one scale factor to scale the operands. For example, scaling the operands may include multiplying the operands by the at least one scale factor. In an embodiment, the scaled operands may be rounded (i.e. to a predefined decimal place) prior to continuing to operation 106.

In operation 106, the element-wise operation is performed on the scaled operands to generate a scaled output. The scaled output refers to the output of the element-wise operation when performed on the scaled operands. The scaled output may be a single data element. Further, the scaling techniques proposed for the element-wise operation can be extended to other use cases also. For example, operation 106 can be a complex tensor operation like concat, split, shuffle, etc. taking scaled tensor operands as inputs to produce a scaled tensor output. The techniques can also be applied to find a common scale factor(s) across tensors based on complex graph structures.

In an embodiment, the element-wise operation may be performed during training of the neural network. In an embodiment, the element-wise operation is performed during inferencing by the neural network. In an embodiment, the scaling of the element-wise operation may be performed to quantize the neural network at training-time or inferencing-time. Quantizing the neural network can provide accelerated execution of the neural network as well as reduce the resource requirements for the neural network.

In an embodiment, the method 100 may further comprise outputting the scaled output from the neural network. In an embodiment, the method 100 may further comprise outputting the scaled output to a next processing node of the neural network. In an embodiment, the method 100 may further comprise outputting the scaled output to a next layer of the neural network. In an embodiment, the method 100 may further comprise outputting the scaled output to a next operation (e.g. element-wise operation) of the neural network.

Further embodiments will now be provided in the description of the subsequent figures. It should be noted that the embodiments disclosed herein with reference to the method 100 of FIG. 1 may apply to and/or be used in combination with any of the embodiments of the remaining figures below.

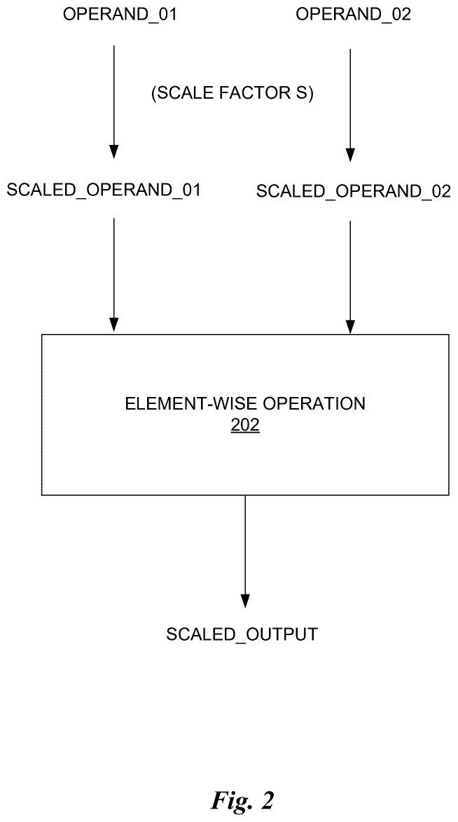

FIG. 2 illustrates a block diagram of the inputs and outputs to a scaled element-wise operation of a neural network, in accordance with an embodiment. The element-wise operation may be scaled in accordance with the method 100 of FIG. 1, in an embodiment. Thus, the embodiments above may equally apply to the present description.

As shown, operands (operand_01 and operand_02) to an element-wise operation 202 are first scaled by a scale factor (or set of scale factors) S to form scaled operands (scaled_operand_01 and scaled_operand_02). While only two operands are shown, it should be noted that some embodiments may include more than two operands to an element-wise operation 202. Also, operation 202 can be replaced by other operations like concat, split, shuffle, or union of tensors in a network. The scale factor(s) S is shared by the operands so that a likewise scaling of the operands is performed. The scaled operands are input to the element-wise operation 202 and the element-wise operation 202 is performed on the scaled operands to generate a scaled output (scaled_output).

In one exemplary implementation where the element-wise operation 202 is an addition operation, Y=X₁+X₂ can be approximated with quantization by Y′=(round(X₁/S)+round(X₂/S))*S=(X′₁+X′₂)*S where S represents the scale factor shared by both operands. This shared scale factor S can be factored out from both operands, making the quantization formulation mathematically sound.

The shared scale factor can be implemented in any desired granularity of the operands as long as corresponding sublocks of both operands X₁, X₂ use the same scale factor. Therefore, the scaling method disclosed herein is not restricted to per-tensor scaled quantization and can be generalized to different variants of block quantization techniques.

FIGS. 3 and 4 described below illustrate possible methods to determine the scale factor(s) to be used on the operands of a particular element-wise operation.

In FIG. 3, a flowchart of a method 300 is illustrated for using statistics computed on the operands of an element-wise operation in a neural network to define one or more scale factors for the operands of the element-wise operation, in accordance with an embodiment. The method 300 may be performed to determine the scale factor S used for the scaled element-wise operation 202 described in FIG. 2 above.

In operation 302, an element-wise operation is performed on operands. In operation 304, statistics are computed for the element-wise operation on a union of the operands. In operation 306, one or more scale factors are defined for the element-wise operation based on the statistics. The scale factor(s) can then be used to scale operands to the element-wise operation.

In one embodiment, the method 300 may be carried out to statically define the scale factor(s). In this embodiment, the scale factor(s) are computed statically prior to inference by running the neural network on some representative input data. For example, representative operands may be input to the element-wise operation in order to compute the statistics on which the scale factor(s) is defined. The scale factor(s) may then be used at training-time, or at inference-time to provide scaling of real-time operands to the element-wise operation.

In another embodiment, the method 300 may be carried out to dynamically define the scale factor(s). In this embodiment, the scale factor(s) are computed dynamically during inference on real-time input data. For example, real-time operands may be input to the element-wise operation in order to compute the statistics on which the scale factor(s) is defined. The scale factor(s) may then be used (still at inference-time) to provide scaling of the real-time operands to the element-wise operation.

In FIG. 4, a flowchart of a method 400 is illustrated for using statistics computed on an output of an element-wise operation in a neural network to define one or more scale factors for operands of the element-wise operation, in accordance with an embodiment. The method 400 may be performed to determine the scale factor S used for the scaled element-wise operation 202 described in FIG. 2 above.

In operation 402, an element-wise operation is performed on operands. In operation 404, statistics are computed for the element-wise operation on an output of the element-wise operation. In operation 406, one or more scale factors are defined for the element-wise operation based on the statistics. The scale factor(s) can then be used to scale operands to the element-wise operation.

With respect to the present embodiment, the method 400, may be carried out to statically define the scale factor(s). In this embodiment, the scale factor(s) are computed statically prior to inference (e.g. and during training) by running the neural network on some representative input data. For example, representative operands may be input to the element-wise operation in order to compute the statistics on which the scale factor(s) is defined. The scale factor(s) may then be used at training-time, or at inference-time to provide scaling of real-time operands to the element-wise operation.

Additional implementations for the method 300 and/or the method 400

In an embodiment, the method 300 and/or the method 400 may include dynamically calibrating fine-grained (e.g. per-block) scale factors and statically calibrating coarse-grained (e.g. per-tensor, per-channel) scale factors.

Further, depending on the actual values of the operands and element-wise operation output, one method 300, 400 of computing the statistics may be more advantageous than the other method 300, 400. Due to this reason, in an embodiment, an error resulting from method 300 may be compared to an error resulting from the method 400 and the method 300, 400 with the lower error may be selected for defining the scaling factor(s) for the element-wise operand. Error may be computed as the mean square error between the output of the element-wise operation when performed on the (e.g. full-precision) operands and the output of the element-wise operation when performed on the scaled (e.g. quantized) operands.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

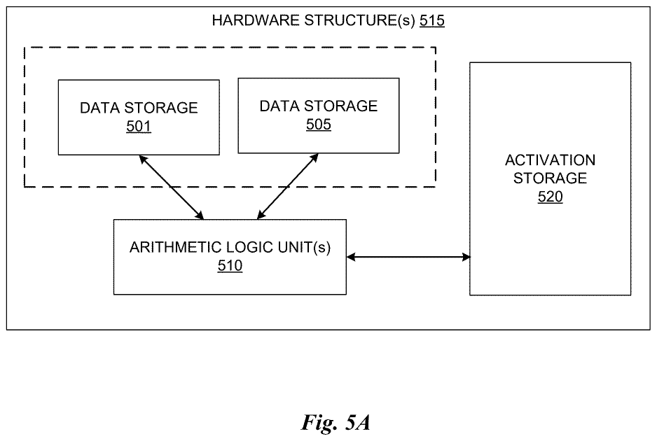

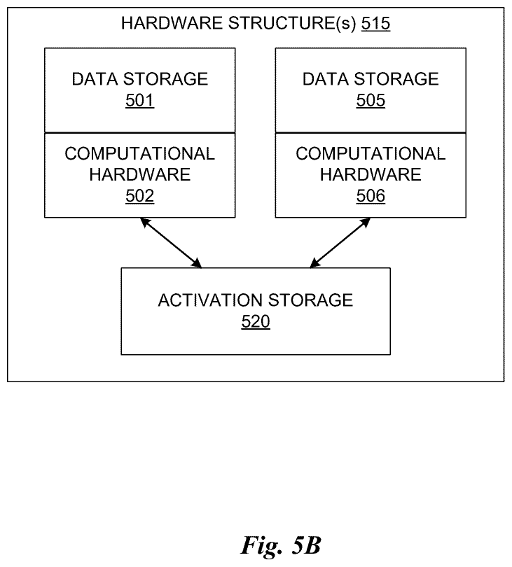

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperpa-rameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding compu-tational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual or-ganization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

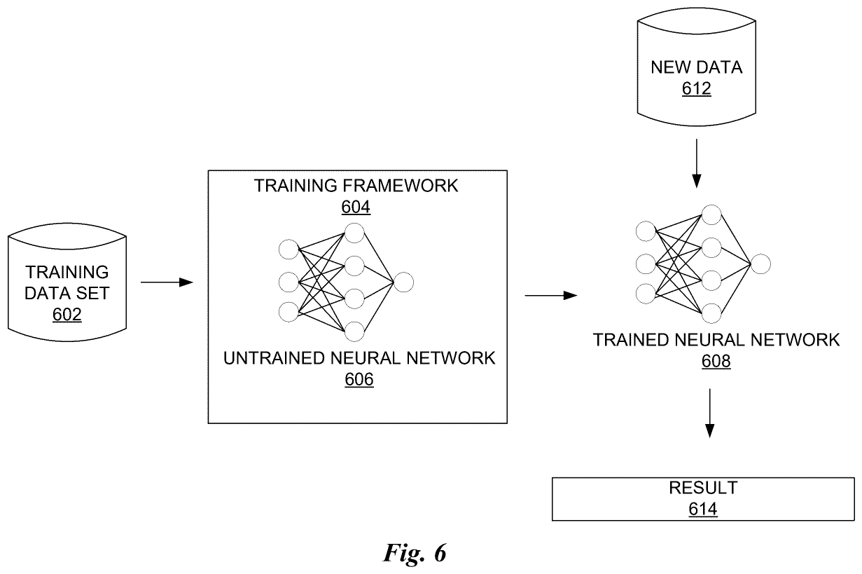

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjust-ment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, un-trained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

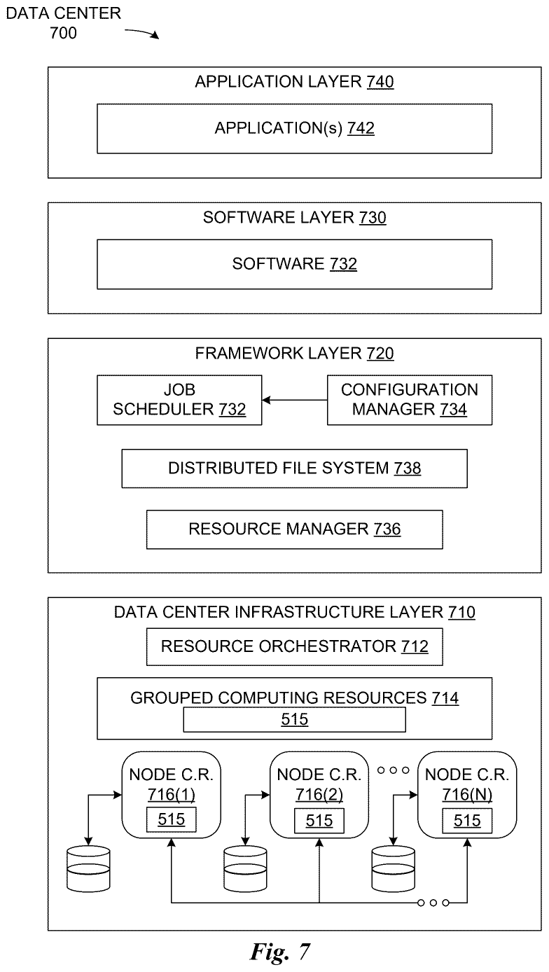

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R. s housed within one or more racks (not shown), or many racks housed in data centers at various geographical locations (also not shown). Separate groupings of node C.R. s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/ or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide scaling of element-wise operations in a neural network. In accordance with FIGS. 1-4, embodiments may include a neural network usable for performing inferencing operations and for providing inferenced data. The neural network may be stored (partially or wholly) in one or both of data storage 501 and 505 in inference and/or training logic 515 as depicted in FIGS. 5A and 5B. Training and deployment of the neural network may be performed as depicted in FIG. 6 and described herein. Distribution of the neural network may be performed using one or more servers in a data center 700 as depicted in FIG. 7 and described herein.

What is claimed is:

1. A method, comprising:
at a device:
determining one or more scale factors to be used for an element-wise operation of a neural network;
scaling operands to the element-wise operation by the one or more scale factors to form scaled operands;
performing the element-wise operation on the scaled operands to generate a scaled output.

2. The method of claim 1, wherein the neural network is a deep neural network.

3. The method of claim 1, wherein the neural network is a transformer.

4. The method of claim 1, wherein the element-wise operation is an element-wise addition operation.

5. The method of claim 1, wherein the element-wise operation is an element-wise subtraction operation.

6. The method of claim 1, wherein the operands each include at least a portion of a tensor.

7. The method of claim 1, wherein the at least one scale factor is statically defined for the element-wise operation.

8. The method of claim 7, wherein the at least one scale factor is statically defined based on a performance of the element-wise operation on different operands comprised of representative input data.

9. The method of claim 8, wherein the at least one scale factor is statically defined based on statistics computed on a union of the different operands.

10. The method of claim 8, wherein the at least one scale factor is statically defined based on statistics computed on an output of the performance of the element-wise operation on the different operands.

11. The method of claim 8, wherein the at least one scale factor is statically defined by:
obtaining a first scale factor statically defined based on statistics computed on a union of the different operands,
obtaining a second scale factor statically defined based on statistics computed on an output of the performance of the element-wise operation on the different operands,
computing a first mean square error between a first output of the element-wise operation when performed on the different operands and a second output of the element-wise operation when performed on the different operands when scaled with the first scale factor,
computing a second mean square error between a third output of the element-wise operation when performed on the different operands and a fourth output of the element-wise operation when performed on the different operands when scaled with the second scale factor,
selecting, as the at least one scale factor, the first scale factor when the first mean square error is lower than the second mean square error, and
selecting, as the at least one scale factor, the second scale factor when the second mean square error is lower than the first mean square error.

12. The method of claim 1, wherein the at least one scale factor is dynamically defined as a function of data included in the operands.

13. The method of claim 12, wherein the at least one scale factor is dynamically defined based on statistics computed on a union of the operands.

14. The method of claim 1, wherein a single scale factor is determined to be used for the element-wise operation.

15. The method of claim 1, wherein a set of scale factors comprised of a plurality of scale factors is determined to be used for the element-wise operation.

16. The method of claim 15, wherein the plurality of scale factors include:
at least one statically defined scale factor, and
at least one dynamically defined scale factor.

17. The method of claim 15, wherein each scale factor in the set of scale factors is determined for a same respective portion of each of the operands.

18. The method of claim 17, wherein the portion is one of:
an operand row,
an operand row sub-part,
an operand column,
an operand column sub-part, or
an operand n-dimensional block.

19. The method of claim 15, wherein two or more scale factors in the set of scale factors are different.

20. The method of claim 1, further comprising, at the device:
rounding the scaled operands prior to performing the element-wise operation on the scaled operands.

21. The method of claim 1, further comprising, at the device:
outputting the scaled output from the neural network.

22. The method of claim 1, further comprising, at the device:
outputting the scaled output to a next processing node of the neural network.

23. The method of claim 1, wherein the element-wise operation is performed during training of the neural network.

24. The method of claim 1, wherein the element-wise operation is performed during inferencing by the neural network.

25. The method of claim 1, wherein the scaling is performed to quantize the neural network.

26. A system, comprising:
a non-transitory memory storage comprising instructions; and
one or more processors in communication with the memory, wherein the one or more processors execute the instructions to:
determine one or more scale factors to be used for an element-wise operation of a neural network;
scale operands to the element-wise operation by the one or more scale factors to form scaled operands; and
perform the element-wise operation on the scaled operands to generate a scaled output.

27. The system of claim 26, wherein the element-wise operation is performed during training of the neural network.

28. The system of claim 26, wherein the element-wise operation is performed during inferencing by the neural network.

29. The system of claim 26, wherein the scaling is performed to quantize the neural network.

30. A non-transitory computer-readable media storing computer instructions which when executed by one or more processors of a device cause the device to:
determine one or more scale factors to be used for an element-wise operation of a neural network;
scale operands to the element-wise operation by the one or more scale factors to form scaled operands; and
perform the element-wise operation on the scaled operands to generate a scaled output.

31. The non-transitory computer-readable media of claim 30, wherein the element-wise operation is performed during training of the neural network.

32. The non-transitory computer-readable media of claim 30, wherein the element-wise operation is performed during inferencing by the neural network.

33. The non-transitory computer-readable media of claim 30, wherein the scaling is performed to quantize the neural network.
